(19) United States
(12) Patent Application Publication
(10) Pub. No.: US 2010/0206112 A1
(43) Pub. Date: Aug. 19, 2010

(54) Linear actuator

(75) Inventors: Pei-Yu Wang, Taichung City (TW); Tom-Min Lin, Taichung City (TW); Ren-Hao Cai, Taichung (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/378,799

(22) Filed: Feb. 19, 2009

(51) Int. Cl. F16H 1/24; F16H 1/18; F16H 1/16

(52) U.S. Cl. 74/424.71; 74/424.7; 74/425

(57) ABSTRACT

A linear actuator has a clutch mechanism settled between a worm gear and a screw of the linear actuator. The clutch mechanism including a disc spring normally stays in a clutched position where a driving power is transmitted from the worm gear to the screw. When the linear actuator is overloaded, the clutch mechanism changes to a declutched position by compressing the disc spring so that the driving power is not transmitted to the screw. Thereby, the clutch mechanism protects internal components of the linear actuator from being damaged, thereby improving durability of the linear actuator.

### BACKGROUND OF THE INVENTION

1. Technical Field

The present invention relates to linear actuators, and more particularly, to a linear actuator having a clutch mechanism that prevents inner components of the linear actuator from disintegrating or being damaged when the linear actuator is overloaded.

2. Description of Related Art

Linear actuators are extensively used as an economic and efficient means to applications where precise positioning control is required. For example, linear actuators are typically used for manageable positioning control in antenna elevator systems, automatic wheelchairs, automatic hospital beds, massage chairs, rehabilitation devices and so on.

In view of the extensive use of linear actuators, it is the manufacturers common goal to improve linear actuators in both structural strength and durability thereof. Thus, one of the points in designing linear actuators is to provide clutch mechanisms so as to prevent inner components of linear actuators from disintegrating or being damaged upon overload. FIG. 1 graphically illustrates a conventional clutch mechanism in a linear actuator. Therein, when the load indirectly burdening a worm gear 92 is greater than a driving power output by the motor 90, a ball 93 normally engaged in a recess 902 on the driving shaft 901 under resilience of a compression spring 94 leaves the recess 902 so that the worm 91 no longer drives the driving shaft 901 to rotate and thereby prevents the driving shaft 901, the worm 91 and the worm gear 92 from disintegrating or being damaged due to the overload. However, in the prior approach, the ball 93 has its limitation in shear stress tolerance and may be worn or sheared by motor torque. Besides, since the ball 93 is positioned by the spring 94 only, overall structural stability of the clutch mechanism is inferior. Therefore, the above shortcomings of the traditional clutch mechanism limit the applications and durability of linear actuators.

### SUMMARY OF THE INVENTION

To remedy the problem of the conventional linear actuator, the present invention provides a linear actuator with a clutch mechanism that effectively prevents inner components of the linear actuator from disintegrating or being damaged upon overload on the linear actuator.

The linear actuator of the present invention is characterized in comprising a worm gear, a screw and a clutch mechanism settled between the worm gear and the screw for conditionally transmitting a driving power from the worm gear to the screw, wherein the clutch mechanism comprises:

a first plate fixedly connected to the worm gear and having a first connecting surface, wherein the first connecting surface has plural raised trapezoidal areas and depressed trapezoidal areas that are alternatively and radially arranged;

a second plate detachably combined with a driving shaft of the screw through a movable mechanism having a second connecting surface, wherein the second connecting surface has plural raised trapezoidal areas and depressed trapezoidal areas that are alternatively and radially arranged, whereby when the depressed trapezoidal areas of the second connecting surface abut the raised trapezoidal areas of the first connecting surface and the raised trapezoidal areas of the second connecting surface abut the depressed trapezoidal areas of the first connecting surface, the first plate and the second plate are closely coupled and thus the clutch mechanism is in a clutched position where the driving power from the worm gear is transmitted to the screw, and whereby when the depressed trapezoidal areas of the second connecting surface abut the depressed trapezoidal areas of the first connecting surface and the raised trapezoidal areas of the second connecting surface abut the raised trapezoidal areas of the first connecting surface, the first plate and the second plate are separated and thus the clutch mechanism is in a declutched position where the driving power from the worm gear is not transmitted to the screw; and

a disc spring, mounted around the driving shaft of the screw, having one end fixedly connected to the driving shaft and an opposite end pushing against the second plate so that when the clutch mechanism is in the clutched position, the disc spring is not compressed, and when the clutch mechanism is in the declutched position, the disc spring is compressed.

In virtue of the aforementioned structure, the present invention achieves the objective of improving torque tolerance of the clutch mechanism so as to extend the application scope of the linear actuator.

Also in virtue of the aforementioned structure, the present invention achieves the objective of providing the efficient clutch mechanism to ensure that the driving power from the worm gear is not transmitted to the screw when the linear actuator is overloaded, so as to protect the internal components of the linear actuator from being damaged, thereby improving durability of the linear actuator.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a schematic drawing showing a linear actuator with a conventional clutch mechanism;

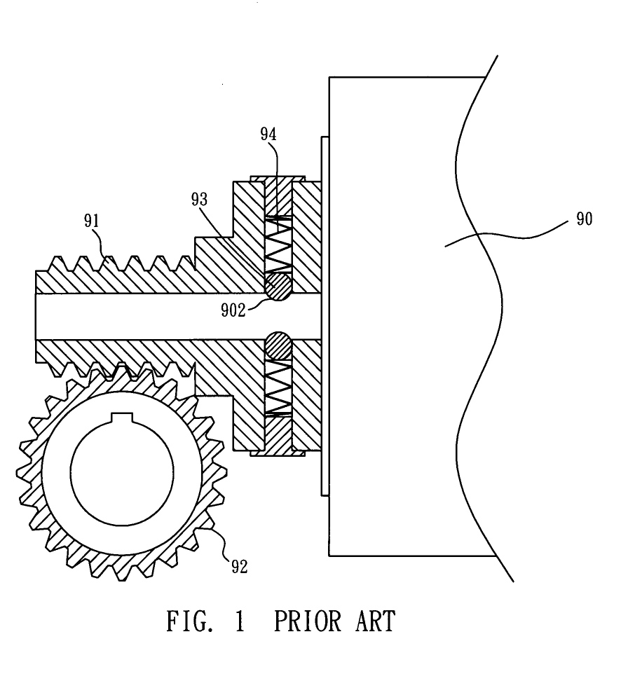

FIG. 2 is an exploded view of a clutch mechanism for a linear actuator according to the present invention;

FIG. 3 is a perspective view of the assembled clutch mechanism according to the present invention;

FIG. 4 is an across-sectional view of the linear actuator of the present invention, showing the assembled clutch mechanism is at it normal clutched position; and

FIG. 5 is another across-sectional view of the linear actuator of the present invention, showing the assembled clutch mechanism is at its declutched position

### DETAILED DESCRIPTION OF THE PREFERRED EMBODIMENTS

While the present invention proposes a linear actuator for positioning control, the control principles thereof are known to one skilled in the art and need not be discussed at any length herein. Meanwhile, the accompanying drawings referred to in the following description are provided for illustrative purposes and need not to be made to scale.

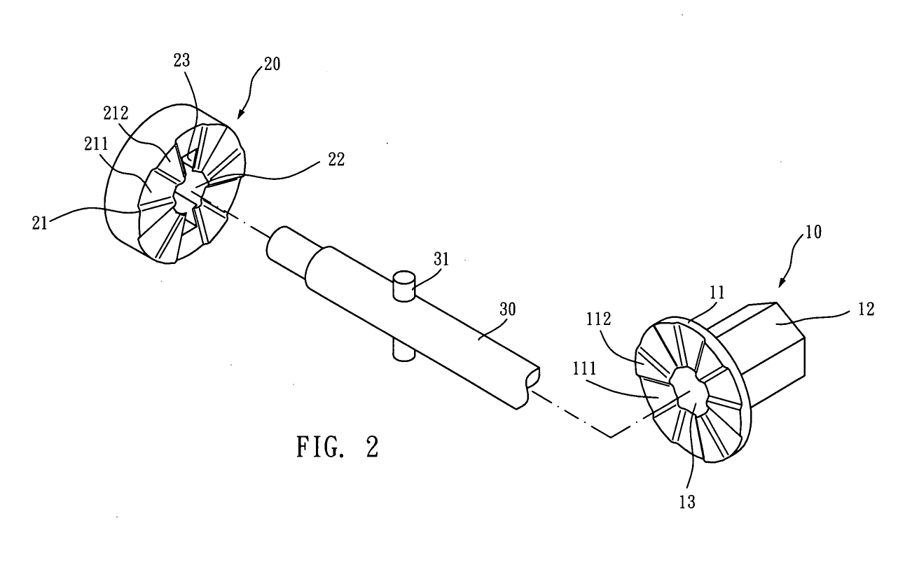

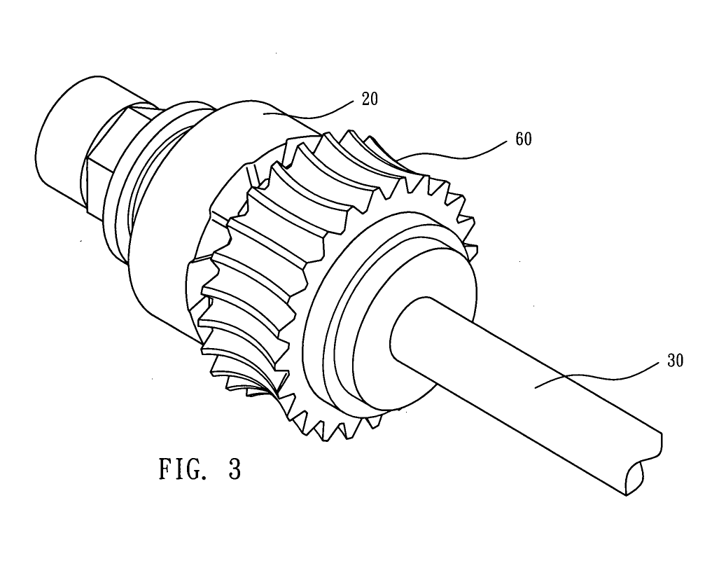

Please refer to FIGS. 2 through 5, wherein a linear actuator with a clutch mechanism is depicted according to the present invention. The linear actuator of the present invention is characterized in comprising a worm gear 60, a screw and a clutch mechanism settled between the worm gear 60 and the screw. The clutch mechanism comprises a first plate 10, a second plate 20, a driving shaft 30 of the screw and a disc spring 40, which will be described in detail below.

The first plate 10 has a first connecting surface 11, a combining section 12 and an axial hole 13 passing through the connecting surface 11 and the combining section 12. The first connecting surface 11 has plural depressed trapezoidal areas 111 and raised trapezoidal areas 112 that are alternatively and radially arranged. The combining section 12 is fixedly settled inside the worm gear 60.

The second plate 20 is a column and has a second connecting surface 21, wherein the second connecting surface 21 has plural depressed trapezoidal areas 211 and raised trapezoidal areas 212 that are alternatively and radially arranged. The second plate 20 further has an axial hole 22 axially passing through the second plate 20. Moreover, a pin recess 23 is formed on the second plate 20. The pin recess 23 radially extends outward from the axial hole 22 and is opened at the second connecting surface 21 so that a pin 31 radially passing through the driving shaft 30 can be received in the pin recess 23.

To assemble the clutch mechanism, the driving shaft 30 has its two ends piercing through the axial holes 13, 22 of the first and second plates 10, 20, respectively, to make the pin 31 settled in the pin recess 23.

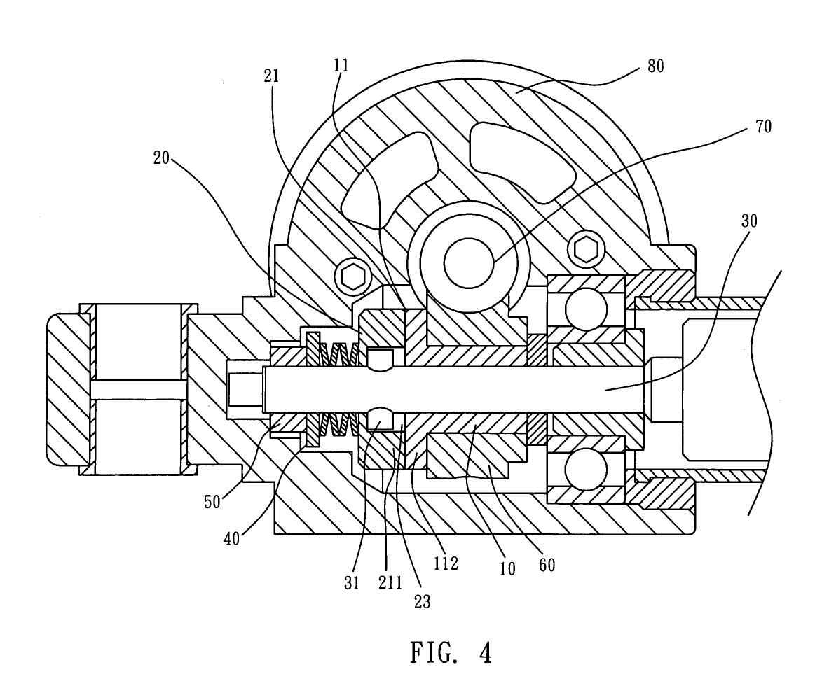

The disc spring 40 is mounted around the driving shaft 30. One end of the disc spring is fixedly coupled with the driving shaft 30 through a nut 50 and an opposite end of the disc spring presses against the second plate 20. Thus, when the disc spring 40 normally pushed the second plate 20 toward the first plate 10, the depressed trapezoidal areas 211 of the second connecting surface 21 abut the raised trapezoidal areas 112 of the first connecting surface 11 and the raised trapezoidal areas 212 of the second connecting surface 21 abut the depressed trapezoidal areas 111. At this time, the first plate 10 and the second plate 20 are closely coupled with each other and the clutch mechanism is in its clutched position, as shown in FIG. 4.

At this time, the power from the motor of the linear actuator is transmitted through the worm to the worm gear 60, and the rotating worm gear 60 in turn drives the first plate 10 combined therein to rotate. Then the first connecting surface 11 of the rotating first plate 10 drives the second plate 20 through the second connecting surface 21. As a result, the first and second plates 10, 20 rotate together and the pin 31 settled in the pin recess 23 of the second plate 20 is driven to move. The rotating pin 31 thus rotates the driving shaft 30. Consequently, the power from the motor of the linear actuator is transmitted to the screw, and the linear actuator works.

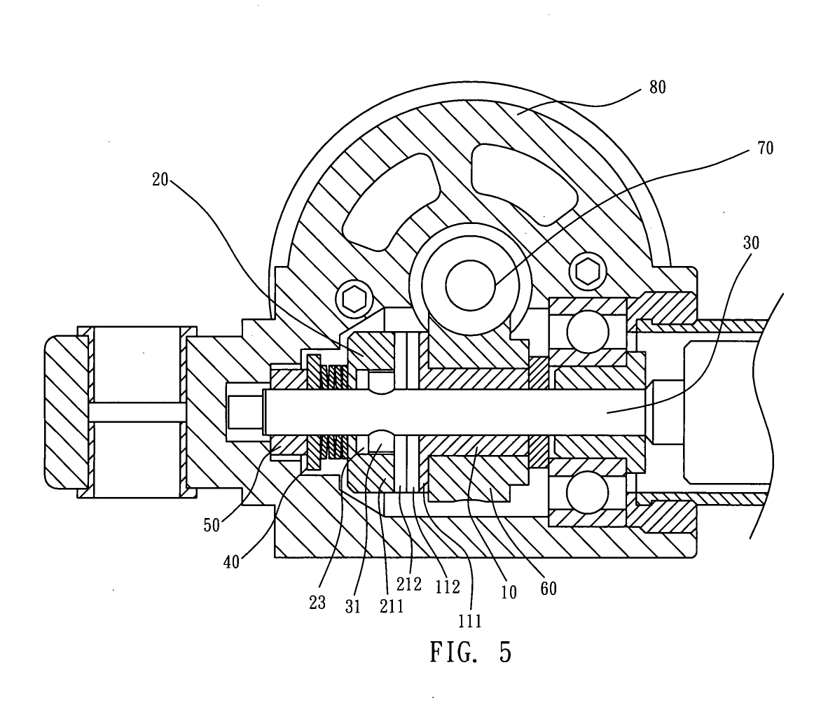

However, when the screw is overburdened to the extent that the first plate 10 driven by the worm gear 60 can no more surpass the resistance from the second plate 20 and the driving shaft 30. At this time, the resistance makes the second plate 20 to counter the rotating force from the first plate 10. Consequently, the first plate 10 rotates and the second plate 20 stays still. Since the first and second contacting surfaces 11, 21 are leaning against each other by slopes of the raised and depressed trapezoidal areas 111, 112, 211, 212, the first contacting surface 11 continuously rotates so that the depressed trapezoidal areas 111 thereof face the raised trapezoidal areas 211 of the second contacting surface 21, while the raised trapezoidal areas 112 thereof face the depressed trapezoidal areas 212 of the second contacting surface 21, and the clutch mechanism is thus in its declutched position, as shown in FIG. 5. In the declutched position, the raised trapezoidal areas 112 of the first plate 10 are in contact with the raised trapezoidal areas 212 of the second plate 20, so that the disc spring 40 is compressed by the second plate 20. In other word, when the linear actuator bears a load that surpasses the upper load limit of the clutch mechanism, the second plate 20 reciprocates between the first plate 10 and the second plate 20. Thereby, all the components are protected from being damaged under the undue load.

Hence, the present invention improves torque tolerance of the clutch mechanism so as to extend the application scope of the linear actuator and ensure that the driving power from the worm provided by the motor is not transmitted to the screw when the linear actuator is overloaded, so as to protect the internal components of the linear actuator from being damaged, thereby improving the durability of the linear actuator.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A linear actuator comprising a worm gear, a screw, and a clutch mechanism settled between the worm gear and the screw, wherein the clutch mechanism conditionally transmits a driving power from the worm gear to the screw, and the clutch mechanism comprises:
a first plate fixedly connected to the worm gear and having a first connecting surface, wherein the first connecting surface has plural raised trapezoidal areas and depressed trapezoidal areas that are alternatively and radially arranged;
a second plate detachably combined with a driving shaft of the screw through a movable mechanism having a second connecting surface, wherein the second connecting surface has plural raised trapezoidal areas and depressed trapezoidal areas that are alternatively and radially arranged, whereby when the depressed trapezoidal areas of the second connecting surface abut the raised trapezoidal areas of the first connecting surface and the raised trapezoidal areas of the second connecting surface abut the depressed trapezoidal areas of the first connecting surface, the first plate and the second plate are closely coupled and thus the clutch mechanism is in a clutched position where the driving power from the worm gear is transmitted to the screw, and whereby when the depressed trapezoidal areas of the second connecting surface abut the depressed trapezoidal areas of the first connecting surface and the raised trapezoidal areas of the second connecting surface abut the raised trapezoidal areas of the first connecting surface, the first plate and the second plate are separated and thus the clutch mechanism is in a declutched position where the driving power from the worm gear is not transmitted to the screw; and
a disc spring, mounted around the driving shaft of the screw, having one end fixedly connected to the driving shaft and an opposite end pushing against the second plate so that when the clutch mechanism is in the clutched position, the disc spring is not compressed while pushing the second plate to abut the first plate, and when the clutch mechanism is in the declutched position, the disc spring is compressed while pushing the second plate to abut the first plate.

2. The linear actuator of claim 1, wherein the movable mechanism between the second plate and the driving shaft comprises a pin recess formed on the second plate, wherein the pin recess radially extending outward from the axial hole is opened at the second connecting surface and a pin radially passing through the driving shaft so that when the driving shaft passes through the axial hole of the second plate, the pin is accommodated in the pin recess.

3. The linear actuator of claim 2, wherein the first plate has an axial hole for allowing the driving shaft to pass through.

4. The linear actuator of claim 1, wherein the disc spring is fixedly coupled with the driving shaft through a nut.
